(19) United States
(12) Patent Application Publication
(10) Pub. No.: US 2021/0257895 A1
(43) Pub. Date: Aug. 19, 2021

(54) SYSTEMS AND METHODS FOR GENERATING ELECTRICITY

(71) Applicant: Jonathan Povegliano, King City (CA)

(72) Inventor: Jonathan Povegliano, King City (CA)

(21) Appl. No.: 17/175,661

(22) Filed: Feb. 13, 2021

Related U.S. Application Data
(60) Provisional application No. 62/977,131, filed on Feb. 14, 2020.

(51) Int. Cl. H02K 35/02

(52) U.S. Cl. CPC H02K 35/02

(57) ABSTRACT

Provided herein is a system for generating electrical current including a transducer subsystem having an upper end and a lower end, the transducer subsystem generating electrical current responsive to objects being dropped individually from the upper end to the lower end under the influence of gravity; and a return subsystem for returning a plurality of the objects collectively to the upper end using upthrust through a fluid body. A method for generating electrical current includes dropping objects individually from an upper end to a lower end of a transducer subsystem under the influence of gravity, wherein the transducer subsystem generates electrical current responsive to the dropping; harvesting the electrical current; and returning a plurality of the objects collectively to the upper end using upthrust through a fluid body.

### CROSS REFERENCE TO RELATED APPLICATION

This application claims priority to U.S. Provisional Patent Application Ser. No. 62/977,131 filed on Feb. 14, 2020, the contents of which are incorporated herein by reference.

### FIELD OF THE INVENTION

The following relates generally to electricity, and more particularly to systems and methods for generating electrical current.

### BACKGROUND OF THE INVENTION

As far back as human history can be analyzed, in terms of humankind's roots, development and growth it is safe to say the rudimentary principles of food, shelter, and water have remained as a constant. These notions have always been, and forever will be found closely tied to the general existence and sustainability of life itself, as without them, it is widely believed that human life would cease to exist. Whether it be in times of the cave men finding shelter in caves and burning fire to provide heat and/or prepare meals for food, or modern-day human beings owning and living in a household where the fundamental necessities of life are all at their disposal, these principles are simple unavoidable. Furthermore, in relation to more common times, the notion of electricity (bearing in mind its many applications) ties greatly to all of these principles, and therefore, justifiably serves as an important staple of human life we all know it as today. The generation of this form of energy (electrical energy/electricity) is at the core of what this application is regarding.

In past times, spanning from today's modern day and age to many decades ago, humankind has remained heavily reliant on means of electrical generation causing harmful or non-ideal side effects to the general environment. Because of this widely accepted concern, the demand and popularity of green focused endeavors has arguable set forth a movement. Influence the mentality of future generations, and providing a general sense of ideal direction to which humanity should strive for in pursuit of continued life through a healthy and sustainable manner.

In 1831, Michael Faraday discovered the principle/concept of what is known today as electromagnetic induction, and through doing so greatly influenced the general notion of electricity, but more specifically the way by which it may be created/generated for many years and future generations to come. The driving force behind many of today's modern-day electrical generators can be attributed to Faraday's discovery as it is essentially the core principle through which these generators are actually above to serve their purpose i.e. generate usable electricity. Specifics regarding this concept is common knowledge and may be found anywhere from textbooks to online documents/articles, however, to summarize briefly, Faraday discovered that a changing magnetic field through a conductor will generate a current.

For instance, a type of currently used generator linked to electromagnetic inductions can be found in generators which burn a form of fuel in order to operate, such as coal, natural gases, or other forms of fuel to ultimately create usable electricity. These types of generators are responsible for the ruling majority of electricity produced in the world today and for many years in the past, however, as briefly mentioned above these particular means of generation come with undesirable side effects to the environment. By virtue of their operation, these particular forms of electric generators emit air pollutants causing harm to the environment through the internal burning of fuel occurring in order to operate them. Despite the fact that these pollutants may seem to be insignificant on a small scale, through a large volume of using such means across the globe this seemly insignificant concern only rises, arguably now to a point causing noticeable harm to the plant. For instance, global warming and the controversy surrounding the notion today. The continued use of these forms of electric generators are further pushing humanity into a hole, a hole the collective intention of millions of people today hopes one day avoid. In light of the harmful side effects, and resultant issues and controversy surrounding these types of generators a need exists in the field for a better, greener and more environmentally friendly means of electrical generation.

This need and demand however has not gone ignored. In more recent times, various actions have taken place in order to address this growing concern. A variety of environmentally friendly/green electric generation alternatives have been created and are currently in use today. For instance, some of these green alternatives may be found in wind, solar and under water current electrical generators and through their used, the risk of environmental harm is completely avoided. Furthermore, even though in a less proportion, these methods still account for a notable proportion of the world's total creation of electricity, however, are still be no means perfect. Each of these alternatives comes with their own pitfalls. For instance, wind powered generators are dependent on the presence of wind, likewise to solar powered generators being dependent on the presence of sun. In times of lacking these aforementioned aspects the corresponding generator fails to work at all, or operates at a lesser productivity and effectiveness. Furthermore, despite the unique pitfalls associated to each of these alternative generation methods, they remain true to their intent of being green and environmentally friendly in by avoiding the need to burn a form of fuel and resultantly pollute the general environment in which we live. Despite the many forms of green/environmentally friendly generators existing today, none of them utilize the kinetic energy resultant of gravity in conjunction with the principles of buoyancy and floating to govern the general operation and function of the machine/generator as the present invention manages to do (to be further detailed throughout the course of this application). In these respects, the present invention substantially departs form the conventional concepts and designs of prior art regarding electrical generation systems and machines.

In light of the currently present and steadily growing demand for a shift towards a greener and healthier earth, a need exists in the field for new ideas and innovations in regards to environmentally friendly and sustainable energy solutions to ultimately aid in the battle to save the plant and foster a sustainable way of life for not only today's generation but the future.

While various arrangements for electricity generation are known, improvements are desirable.

### SUMMARY OF THE INVENTION

In accordance with an aspect of the following, there is provided a system for generating electrical current comprising a transducer subsystem having an upper end and a lower end, the transducer subsystem generating electrical current responsive to objects being dropped individually from the upper end to the lower end under the influence of gravity; and a return subsystem for returning a plurality of the objects collectively to the upper end using upthrust through a fluid body.

In an embodiment, the transducer subsystem comprises at least one stationary transducer having a coil; and the objects comprise magnets.

In an embodiment, each of the objects is associated with a respective one of the at least one stationary transducer.

In an embodiment, the objects are substantially identical.

In an embodiment, the return subsystem returns all of the objects collectively to the upper end using upthrust through the fluid body.

In an embodiment, the system further comprises a suspension mechanism associated with the upper end of the transducer subsystem for selectively suspending the objects above, and releasing the objects into, the transducer subsystem.

In an embodiment, the return subsystem comprises at least one container dimensioned to convey the plurality of the objects collectively to the upper end.

In an embodiment, each container has an interior chamber and a sealable port through which the objects can be received within the interior chamber, and each container comprises a buoyancy subsystem for conditioning each container to selectively rise or sink within the fluid body.

In an embodiment, the buoyancy subsystem comprises a fill subsystem for selectively permitting fluid from the fluid body to enter the interior chamber thereby to reduce buoyancy of the container causing the container to tend to sink in the fluid body; and a purge subsystem for selectively causing fluid in the interior chamber to be released into the fluid body to increase buoyancy of the container thereby to cause the container to tend to rise in the fluid body.

In an embodiment, the purge subsystem comprises a resealable container lid associated with an upper opening of the container; and a riser for traversing the interior chamber to push fluid within the interior chamber out of the upper opening of the container while the lid is not sealing the container.

According to another aspect, there is provided a method for generating electrical current comprising dropping objects individually from an upper end to a lower end of a transducer subsystem under the influence of gravity, wherein the transducer subsystem generates electrical current responsive to the dropping; harvesting the electrical current; and returning a plurality of the objects collectively to the upper end using upthrust through a fluid body.

In an embodiment, the transducer subsystem comprises at least one stationary transducer having a coil; and the objects comprises magnets.

In an embodiment, each of the objects is associated with a respective one of the at least one stationary transducer.

In an embodiment, the objects are substantially identical.

In an embodiment, returning comprises returning all of the objects collectively to the upper end using upthrust through the fluid body.

In an embodiment, the method further comprises prior to dropping the objects, suspending the objects above the transducer subsystem.

In an embodiment, the returning comprises causing a plurality of the objects to be conveyed collectively within at least one container in the fluid body from the lower end to the upper end.

In an embodiment, the method comprises causing the plurality of objects to move into the container; and after the at least one container has conveyed the plurality of objects to the upper end, causing the plurality of objects to move out of the container.

In an embodiment, the method comprises after moving the array of objects out of the at least one container, permitting fluid from the fluid body to enter an interior chamber of the at least one container thereby to reduce buoyancy of the at least one container causing the at least one container to sink within the fluid body towards the lower end of the transducer subsystem; retaining the at least one container near to the lower end of the transducer subsystem; and purging fluid from the interior chamber into the fluid body to increase buoyancy of the at least one container thereby to cause the at least one container to tend to rise in the fluid body, wherein the at least one container is temporarily kept from rising despite the increased buoyancy due to the retaining, wherein the purging fluid comprises unsealing a container lid associated with an upper opening of the at least one container; pushing fluid within the interior chamber out of the upper opening of the at least one container while the lid is unsealed from the at least one container; and re-sealing the container lid.

Embodiments described herein are advantageous in enabling objects to be dropped individually to generate electrical current, but to be treated collectively—for example, as an array or group, or as two or more arrays or groups each having multiple objects, or even physically individually but uniformly simultaneously—while being returned to a position for continued generating.

Other aspects and embodiments will become apparent upon reading the following description.

### BRIEF DESCRIPTION OF THE DRAWINGS

Embodiments of the invention will now be described with reference to the appended drawings in which:

FIG. 1 is a perspective view of an electrical generator system with—for ease of explanation—translucent walls for viewing internal components, according to an embodiment;

FIG. 2 is a sectioned elevation view of the electrical generator system of FIG. 1;

FIG. 3 is another sectioned elevation view of the electrical generator system of FIG. 1, showing an object starting to individually drop from the array of objects in an upper anteroom under the influence of gravity;

FIG. 4 is another section elevation view of the electrical generator system of FIG. 1, with the object having entered into, and resting within, a lower anteroom;

FIG. 5 is a perspective view of the electrical generator system of FIG. 1, after several objects have been released and are at different stages of dropping or are resting within the lower anteroom;

FIG. 6 is a perspective view of the electrical generator system of FIG. 1, after all of the objects have dropped into the lower anteroom and are resting, as an array, within the lower anteroom;

FIG. 7 is a perspective view of the electrical generator system of FIG. 1, with the array of objects having been collectively pushed via an open exit port of the lower anteroom into a container via its open sealable port;

FIG. 8 is a perspective view of the electrical generator system of FIG. 1, with the array of objects inside the container with its sealable port having been closed, and the exit port of the lower anteroom having been closed;

FIG. 9 is a sectioned elevation view of the container of the electrical generator system having been released and starting to rise so that it is able to rise upwards through a fluid body to convey the array of objects upwards through the fluid body under the influence of upthrust;

FIG. 10 is a sectioned elevation view of the container of the electrical generator system having reached the surface of the fluid body and having docked adjacent to the upper anteroom, with the sealable port still closed;

FIG. 11 is a sectioned elevation view of the container of the electrical generator system having reached the surface of the fluid body and having docked adjacent to the upper anteroom, with the sealable port having been opened;

FIG. 12 is a sectioned elevation view of the array of objects having been urged out of the container to the upper end of the transducer subsystem;

FIG. 13 is a sectioned elevation view of the electrical generator system with the container in “fill” mode during which fluid from the fluid body is permitted to enter into its interior chamber thereby to progressively reduce the buoyancy of the container with respect to the fluid body;

FIG. 14 is a sectioned elevation view of the container of the electrical generator system having been reduced in buoyancy sufficiently to enable it to drop down through the fluid body towards the lower anteroom;

FIG. 15 is a sectioned elevation view of the container of the electrical generator system having reached the bottom of the fluid body and having been again been retained, or docked, adjacent to the lower anteroom;

FIG. 16 is a sectioned elevation view of a lid of the container of the electrical generator system having been released from the retained container thereby to separate from the upper opening of the container;

FIG. 17 is a sectioned elevation view of fluid being pushed out of the retained container of the electrical generator system via the upper opening of the container by a riser traversing the interior chamber of the elevator thereby to purge fluid that had been permitted to enter the interior chamber from the fluid body back into the fluid body, thereby to again increase the buoyancy of the container;

FIG. 18 is an enlarged sectioned elevation view of the lid having returned to the container thereby to be retained to re-close the upper opening of the container; and

FIG. 19 is an enlarged sectioned elevation view of the riser having receded fully from the interior chamber thereby to permit the interior chamber, substantially purged of the fluid from the fluid body, to fill with air from the ambient and to again receive the array of objects once they have again been dropped.

### DETAILED DESCRIPTION

In this description, systems and methods are provided for generating electrical current when an object is dropped under the influence of gravity from an upper end of a transducer subsystem to a lower end. Systems and methods are provided for returning the object to the upper end of the transducer subsystem using upthrust through a fluid body such as a container of water, a pond, a well or some other fluid body. Return of the object to the upper end of the transducer subsystem is useful for enabling the same object to be repeatedly dropped through the transducer subsystem thereby to repeatedly generate electrical current. Using the influence of gravity to move the object with respect to the transducer subsystem takes advantage of the power inherent in the pull of gravity to move the object. Similarly, using the upthrust of a fluid body to help return the object to an initial position with respect to the transducer subsystem takes advantage of the power inherent in the upthrust of the fluid to move the object. This principle is referred to herein as drop-generate, upthrust-return (or, “DGUR”). This description includes various explanations of techniques and subsystems for generating upon dropping, and for returning using upthrust. Also provided are various explanations of techniques and subsystems for transitioning the object or several such objects between the transducer subsystem and the return subsystem. Also provided are various explanations of techniques and subsystems for putting the subsystems and their constituent components into various states to facilitate the movement of the object(s) either for dropping or for returning.

Furthermore, this description emphasizes systems and methods designed to reduce, and where possible minimize, the interaction time of a user or other source of power, relative to the time during which electricity is being generated. It will be appreciated that, while the system can be operated to drop objects in seriatim over a particular time span—such as an hour or two hours or many hours—the user or other source of power interacts with the objects collectively, rather than individually, to return the objects to the upper end. Such interaction may take only a few minutes, after which the system can again operate to generate electricity over a longer period, as described and shown herein. Once the objects have all been dropped over the course of the dropping time, the user or other source of power can return to the system and interact with the system to put the array of objects back into a condition to be dropped again. As such, this description emphasizes Short-Interaction DGUR, or SIDGUR, thereby to—in a sense—enable a user or other source of power to cause the system to generate electricity for significantly longer than the time the user or other source of power is expected to normally interact with the system. This also refers to system operating in a way that greatly leverages—using gravity and buoyancy primarily—the little physical energy required of the user or other source of power to keep the system operating essentially continuously to generate electricity.

It will be appreciated that the present application is directed to the conversion of potential and kinetic energy of an object into electrical energy, and for imbuing the object with potential and kinetic energy through the operation of the system described herein and of other systems that operate according to DGUR or SIDGUR. This electrical energy once harvested may at least partially be brought back into the system and used to carry out the steps or operate the systems and subsystems described herein. The electrical energy once harvested may be used and/or stored elsewhere entirely, or may once harvested be converted from electrical energy into some other form or forms of energy. The particular method of harvesting electrical energy, and the downstream use or storage of the electrical energy once it is generated as described herein, are not particularly the subject of this description.

While various sources of automatic power can be used as inputs for controlling and/or operating the system and its various subsystems, this description contemplates the moving of the array of objects into and out of the container being done under the control of a user. Such user interaction may be aided with machines such as those that can provide mechanical advantage, and may even be aided by powered machines.

In this description, the present inventor is not proposing that the systems of the present invention can operate in perpetuity to conduct conversion of this potential and kinetic energy to electrical current and repeat as described without, either continually or intermittently, receiving power into the system from a person. Rather, this description is directed to savings in cost by using both gravity and upthrust in the fluid body for return, as well as both the time-leveraged and mechanically-leveraged involvement of outside power such as manpower. These enable production of electricity over time using as little as possible of the time and physical input of a user and/or other source of power or involvement.

Arrays of systems such as those disclosed herein may be operated continuously using a single user or other source of power. This might be done by the user or other source of power attending to the moving of objects collectively between the transducer subsystem and the return subsystem of one such electrical generator system at a time that another like or similar electrical generator subsystem is already generating electricity using gravity or using buoyance to return its respective objects. Then, once the first system is attended to and can run for a time on its own, the user or other source of power can return its attention to moving objects between the transducer subsystem and the return subsystem of the second system, and so forth. Multiple such systems can be operated simultaneously and yet attended to by a single user or other source of power because of the configurations described herein that enable the user or other source of power spend little time and energy attending to each system, relative to the time and energy the system is running and generating. It will therefore be appreciated that, in such an arrangement, the compensation of a particular user or source of power for attending to multiple such systems can be justified in terms of the value of the electricity generated by the multiple systems, and not only the value of the electricity generated by one of them.

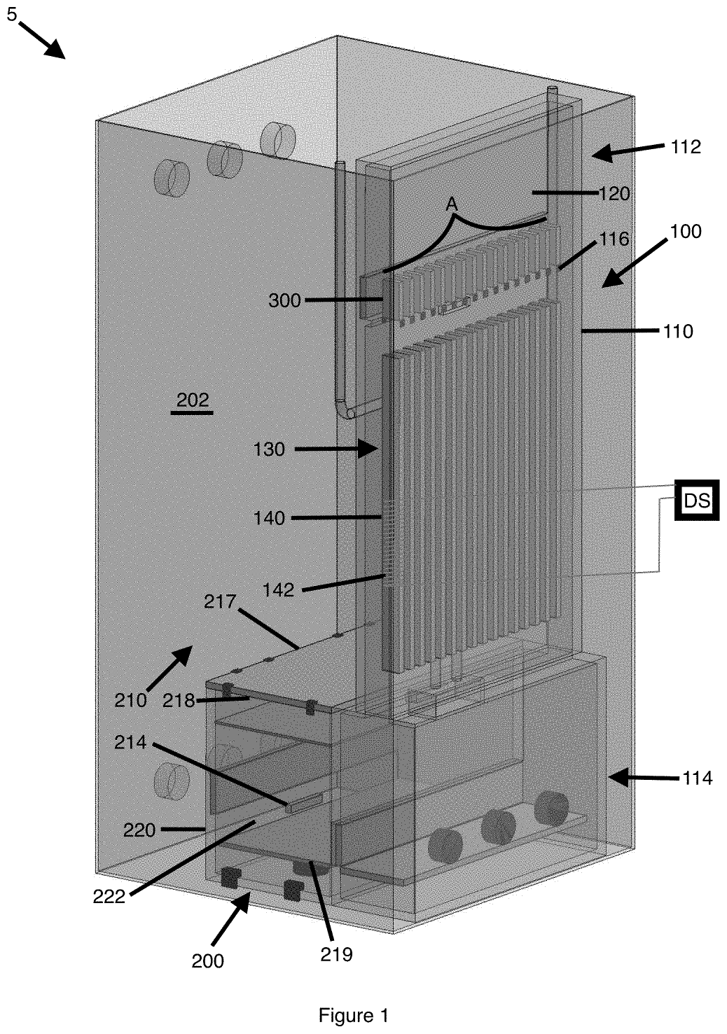

FIG. 1 is a perspective view of an electrical generator system (EGS) 5 with—for ease of explanation—translucent walls for viewing internal components, according to an embodiment. It will be appreciated that EGS 5 represents an example of many ways of configuring a system for facilitating SIDGUR. In this embodiment, EGS 5 includes a transducer subsystem 100 and a return subsystem 200. In this embodiment, transducer subsystem 100 includes a generally vertically oriented enclosure 110 having an upper end 112 and a lower end 114.

At upper end 112 of enclosure 110 is an upper anteroom 120 sized to receive and temporarily hold an array A of objects 300 stacked lengthwise (generally, into the page). In this embodiment, each of objects 300 includes at least one magnet, and may include other components. In this embodiment, objects 300 are substantially identical, and are shaped as rectangular plates with a small thickness dimension relative to their length and width. This enables objects 300 to be stackable and manipulable in system 5 as an array A, if required.

In the state of EGS 5 shown in FIG. 1, each object 300 in array A within upper anteroom 120 is suspended above a respective channel 130 by a respective suspension mechanism 116 that is controllable to be in either a suspension condition or a release condition. When in the suspension condition, as shown in FIG. 1, suspension mechanism 116 keeps a respective object 300 from dropping downwards out of upper anteroom 120 under the influence of gravity. Only one suspension mechanism 116 is shown in FIG. 1, but each object 300 is, in this embodiment, suspended by a like suspension mechanism 116. When switched to its release condition, suspension mechanism 116 ceases impeding object 300 from dropping downwards out of upper anteroom 120 under the influence of gravity, as will be described in further detail below. Once an object 300 has been released in this manner, suspension mechanism 116 is controlled to switch from its release condition back to its suspension condition so that the object can be suspended again once returned to upper anteroom 120, as will be described herein. In this embodiment, this control is managed by a computing system controlling a solenoid system that can withdraw and extent a post on either lower end of an object, thereby to respectively release or retain the object. In some embodiments, all of the suspension mechanisms 116 are controlled in unison to all switch between suspension condition and release condition simultaneously. However, in order to generate electrical current over an extended period, suspension mechanisms 116 are controlled to switch from suspension condition to release condition in a sequence. In this way, electrical current can be continuously generated even without the involvement of a user over spans of time. The sequence of dropping can be scheduled so that there is no gap between electrical current being output from transducer subsystem 100 during the dropping sequence, thereby blending the pulses from individual drops into a continuous stream of power.

Suspension mechanisms 116 can be controlled to switch from release condition to suspension condition in a sequence, or at least not simultaneously, or all at once at some time after all objects 300 have dropped during a particular cycle.

In this embodiment, each channel 130 beneath upper anteroom 120 includes a tube 132 and associated transducer 140. In this embodiment, each transducer 140 includes a winding 142 coiled around a respective tube 132, in which electrical current is induced when a respective magnetic object 300 is released and drops through tube 132. Each winding 142 is, in turn, connected to a downstream system or systems DS for harvesting the induced electric current. Downstream system or systems DS may be a storage system(s), a power conditioning system(s), an electrical distribution grid system(s), or any other system(s) suitable for storing, conditioning or otherwise making use of the electrical current induced in windings 142. It will be appreciated that the same or different downstream systems DS could be connected to the same or different windings 142, depending on the implementation. Furthermore, as indicated above, one or more windings 142 may be connected back to system 5 in some manner for bringing current back into system 5 for powering some aspect of it. Each channel 130 has an associated transducer 140 and winding 142. However, only the first of channels 130 is shown in FIG. 1 with its respective transducer 140 and winding 142, the drawing having been simplified for ease of illustration. Furthermore, also for ease of illustration, subsequent figures do not show any transducer 140 and winding 142, but are to be understood to be representing an EGS 5 that includes these components for each of the channels 130.

At lower end 114 of enclosure 110, beneath channels 130, is a lower anteroom 150 sized to receive and temporarily hold, individually and as an array, objects 300 stacked lengthwise (generally, into the page). Objects 300 enter lower anteroom 150 from above, after having dropped from upper anteroom 120 and after having passed through respective channels 120 thereby to induce electrical current in respective windings 142. System 5 may be configured to cause objects 300 to enter lower anteroom 150 substantially simultaneously if they are released substantially simultaneously, or to enter lower anteroom 150 one-by-one. In this embodiment objects 300 are returned together from lower end 114 to upper end 112, as will be described. Lower anteroom 150 includes an exit port 152 through which array A of objects 300 can be urged by return subsystem 200. Lower anteroom 150 serves to hold objects 300 as they are dropped and re-accumulate as an array A over time, so that objects 300 can be manipulated as array A once the user returns to move array A into the return subsystem 200 as will be described.

In this embodiment, return subsystem 200 includes a fluid body 202 and an elevator 210 including a container 220 in fluid body 202. Container 220 has an interior chamber 222, and a sealable port 224 in an external wall of container 220 is sized to interface with exit port 152. Interior chamber 22 is sized to, when open, receive array A of objects 300 via exit port 152 into interior chamber 222. Array A of objects 300 may be urged into the interior chamber 222 via exit port 152 and sealable port 224 using a hydraulic pusher 230 that pushes array 300 leftwards (as seen in FIG. 1) out of lower anteroom 150. Sealable port 224 can be controlled to be opened or closed, and when closed seals interior chamber 222 from ingress of fluid.

Individual objects 300 have respective densities and volumes that permit them to drop through the medium of air in order to interact with respective electrical transducers and reach the bottom of transducer subsystem 100. Individual objects 300 may not themselves be buoyant when in the medium of fluid in fluid body 202. In order to convey objects 300 upwards through fluid body 202, therefore, container 200, which has controllable buoyancy as will be described, serves as somewhat of a vessel that is itself conveyed upwards using upthrust of the fluid body 202. Container 200 has a greater volume than individual objects 300, such that the combination of container 200—otherwise empty—and array A of objects 300, is subject to upthrust—i.e., is buoyant—in fluid body 202. As will be described, container 200 can be additionally filled with fluid from fluid body 202 thereby to decrease overall buoyancy, as will be described.

Elevator 210 includes a buoyancy subsystem to condition container 220 to either sink or rise within fluid body 202. In this embodiment, the buoyancy subsystem includes a fill subsystem including a valve 214 controllable to permit fluid from fluid body 202 to enter from the exterior of container 220 into interior chamber 222 thereby to reduce the buoyancy of container 220. This causes container 220 to tend to sink in fluid body 202. The buoyancy subsystem also includes a purge subsystem controllable to cause fluid to exit from interior chamber 222 into fluid body 202. This causes container 220 to tend to rise in fluid body 202.

In this embodiment, the purge subsystem includes a releasable container lid 217 associated with an upper opening 218 of container 220, and a riser 219 associated with the interior chamber 222. Riser 219 includes a platform substantially covering the floor area of interior chamber 222 and can be controlled to traverse interior chamber 222 (move upwards and downwards) under the influence of hydraulic lifters to push fluid out of interior chamber 222 into fluid body 202. The fluid is pushed out via upper opening 218 when lid 217 is not in place within upper opening 218 to seal it, and to return to the floor of interior chamber 222.

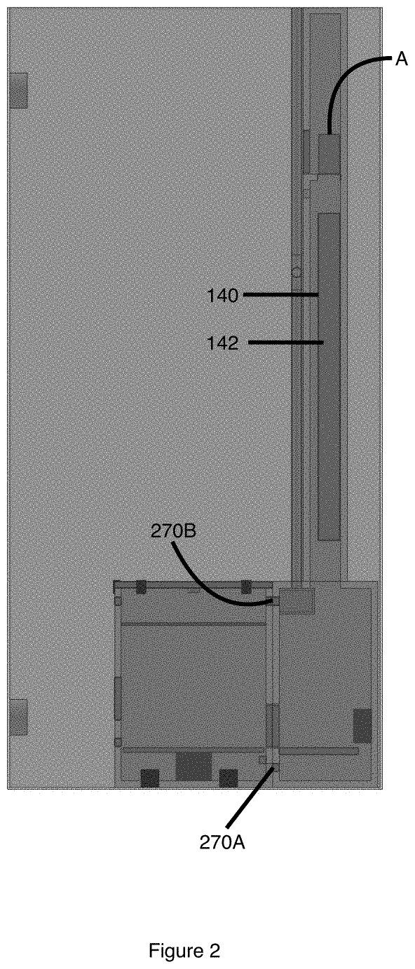

FIG. 2 is a sectioned elevation view of EGS 5. Air passage arrangements 270A, 270B extend from within interior chamber 222 to a source of ambient air. This enables conveyance of air to and from the ambient and interior chamber 222, thereby to provide equalization of air pressures to avoid creating vacuum pressure during purging of fluid from interior chamber 222 and, as described, the subsequent return of riser 219 to the floor of interior chamber 222.

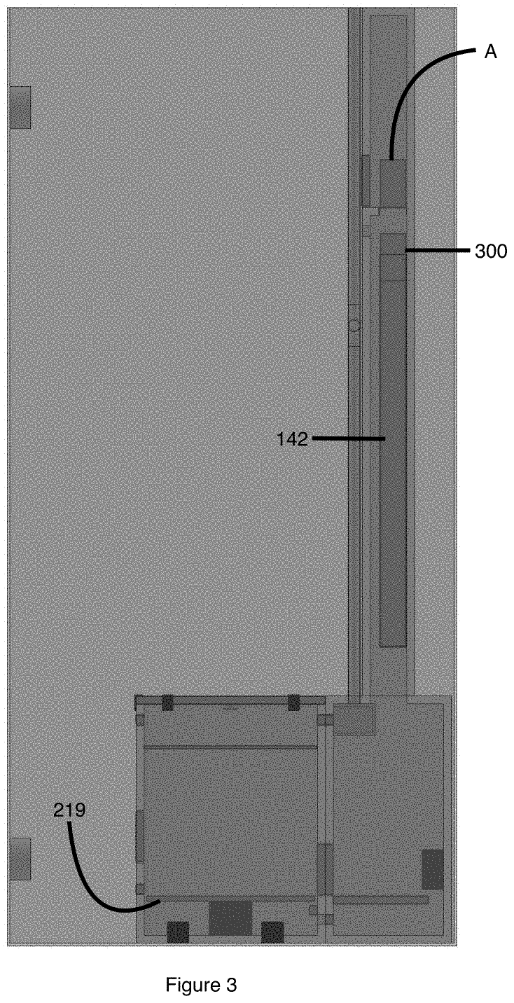

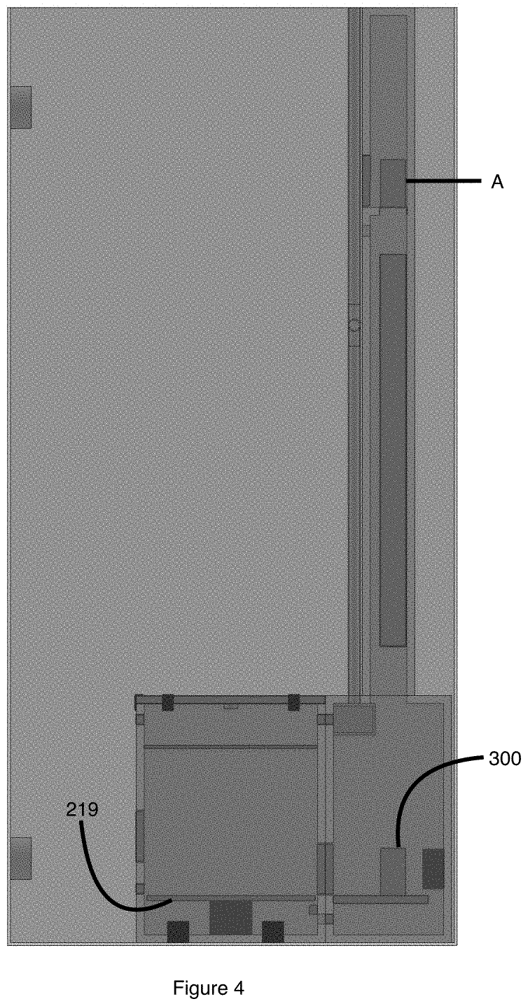

The operation of EGS 5 will be described with reference to subsequent drawings. FIG. 3 is another sectioned elevation view of EGS 5, showing an object 300 starting to individually drop from the array A in upper anteroom 120 under the influence of gravity. Most objects 300 are shown as still suspended—for the moment—by suspension mechanism 116 within upper anteroom 120 at upper end 112 of enclosure 110 by suspension mechanism 116. The initially-dropped object 300 falls towards a respective winding 142 thereby to generate current in winding 142 due to the interaction of object 300—having a magnet—and proximal winding 142. The current is harvested by downstream system or systems DS as explained above. FIG. 4 is another section elevation view of EGS 5, with the initially dropped object 300 having entered into, and resting within, lower anteroom 130.

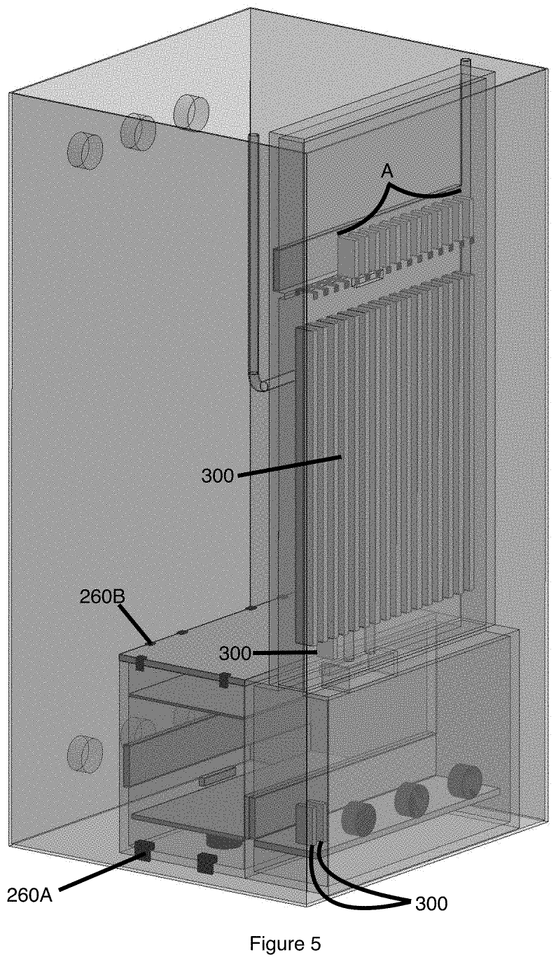

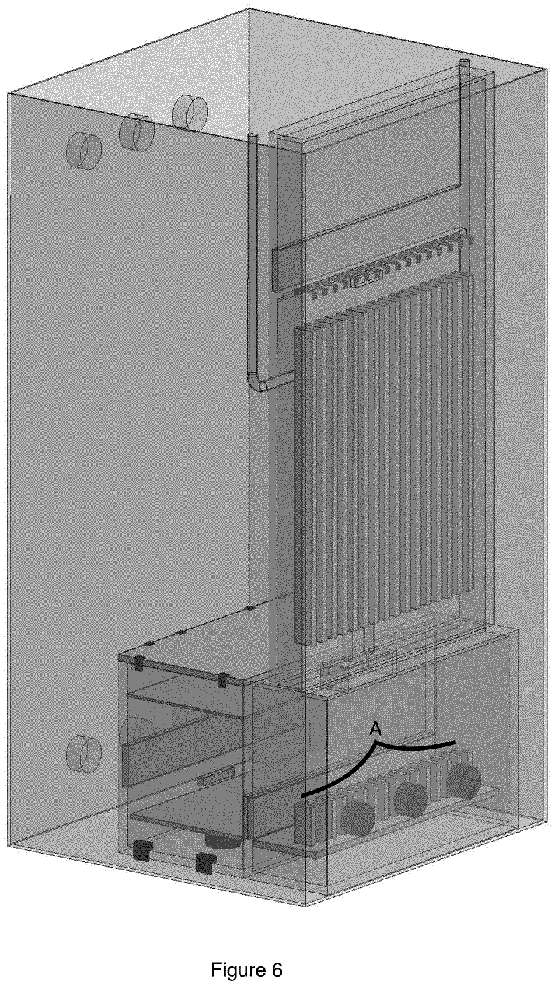

FIG. 5 is a perspective view of EGS 5, after several objects 300 have been released and are at different stages of dropping or are resting within lower anteroom 130. The dropping of objects 300 continues thereby to induce current in respective windings 142 until no more objects are available in upper anteroom 120 to release for dropping. FIG. 6 is a perspective view of EGS 5, after all of objects 300 have dropped into lower anteroom 130 and are resting, as an array A, within lower anteroom 130. At this point, return subsystem 200 can be engaged in order to return objects 300 to upper anteroom 120, as will be described.

It will be appreciated that the time over which the steps shown in FIGS. 3 through 6 will depend at least on the number of objects 300 chosen for a given implementation, and at what the release schedule is set. However, it will also be appreciated that during the dropping, no user interaction is needed. As such, larger numbers of objects in a given array A, as well as—if appropriate—longer times between individual drops, will extend the time during which EGS 5 can operate before a user needs to interact with EGS 5 to move the array A.

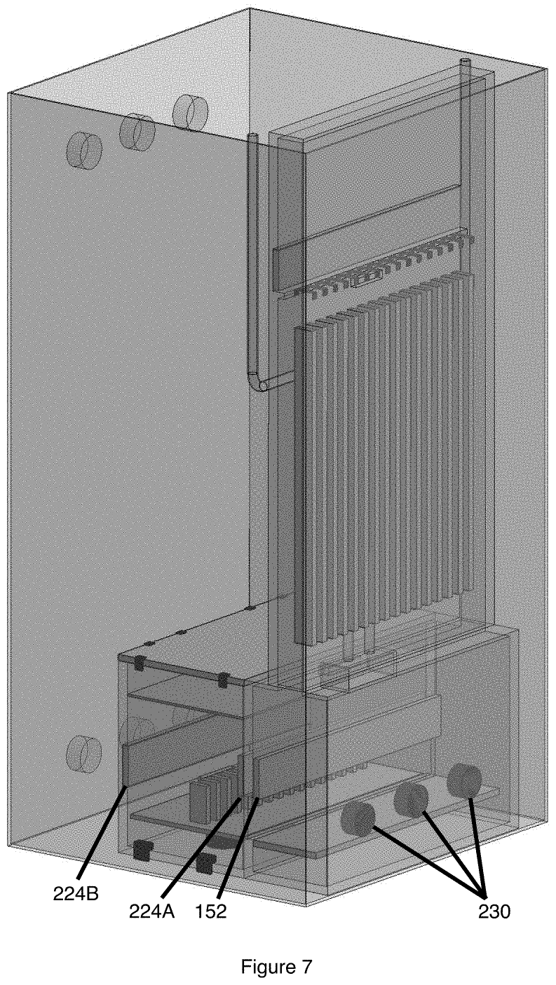

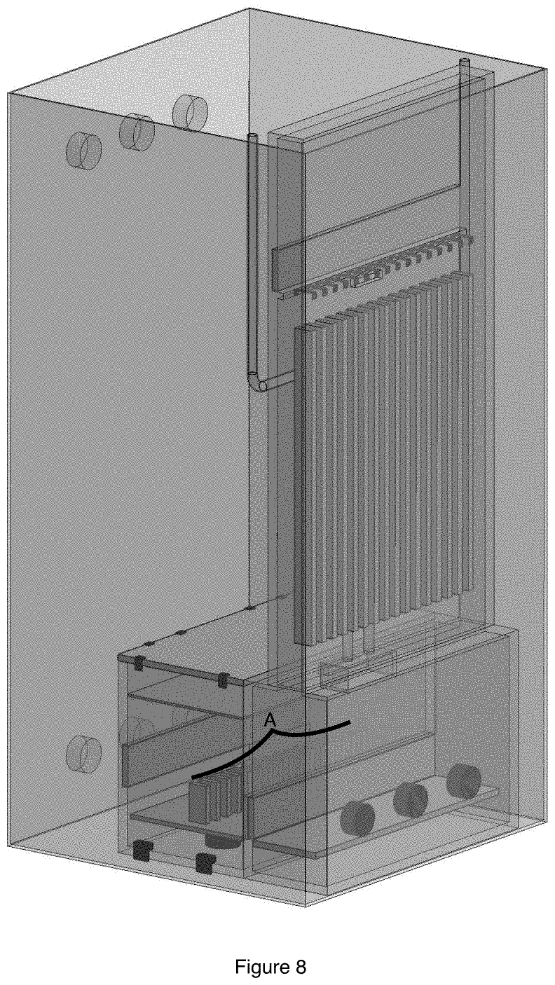

FIG. 7 is a perspective view of EDS 5, with the array A of objects 300 having been collectively pushed via an open exit port 152 of lower anteroom 130 and open sealable port 224 by hydraulic pusher 230 into a container 220. Hydraulic pusher 230 provides a mechanical advantage to allow, for example, a user to move array A into container 220. Array A of objects 300 is received within interior chamber 222 of container 220. FIG. 8 is a perspective view of EGS 5, with the array A of objects 300 inside container 220 with its sealable port 224 having been closed, and exit port 152 of lower anteroom 130 having also been closed. In FIG. 8, a retention mechanism 260A is in a retention state, in which retention mechanism 260A is retaining container 220 submerged.

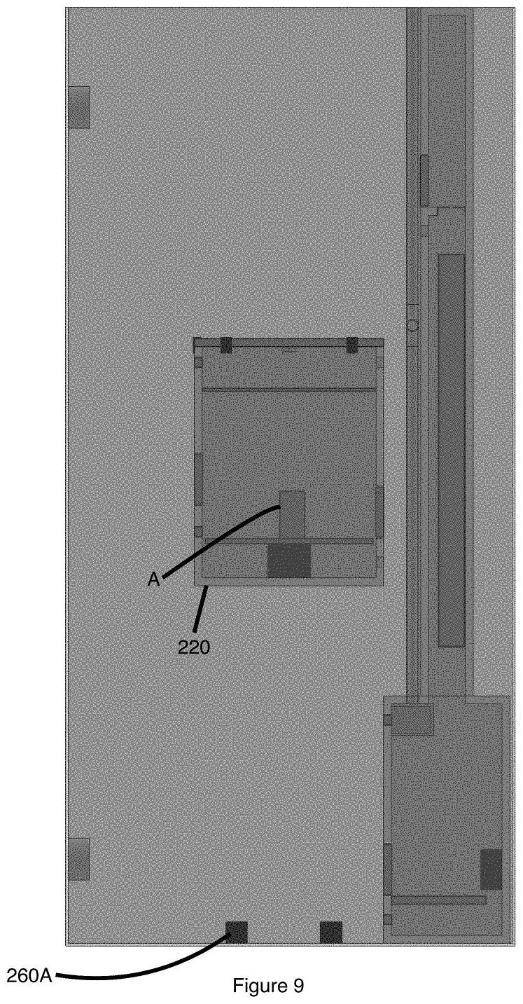

FIG. 9 is a sectioned elevation view of container 220 of EGS 5 having been released and starting to rise so that it is able to rise upwards through a fluid body 202 to convey array A of objects 300 upwards through fluid body 202 under the influence of upthrust. A retention mechanism 260A for retaining container 220 despite its buoyancy has changed from its retention state to a release state. Due to the buoyancy of container 220, when retention mechanism 260A enters release state, container 220 is free to rise under the influence of upthrust within fluid body 202 towards the surface of fluid body 202 and thus, as depicted, towards upper anteroom 120.

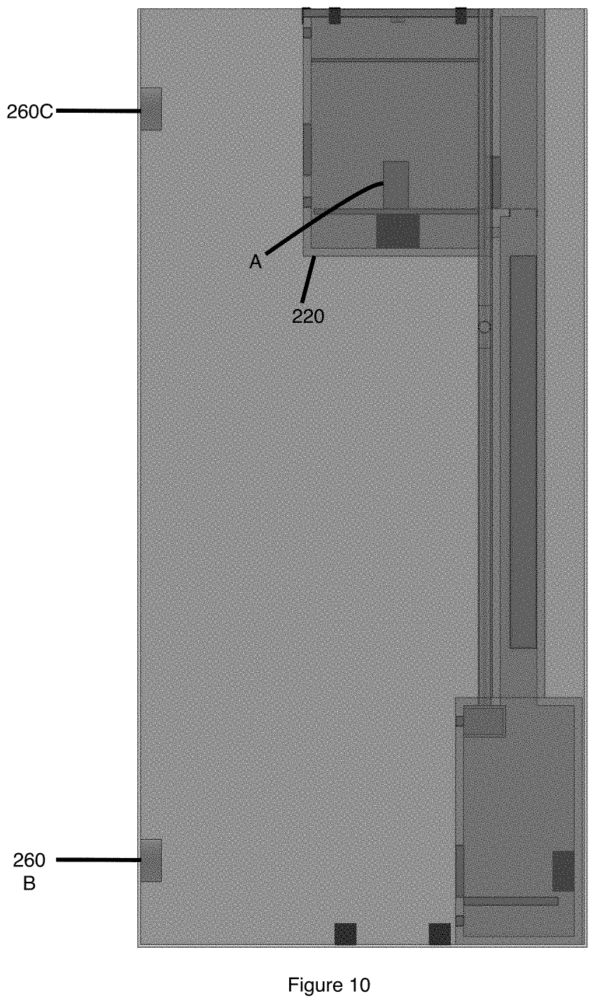

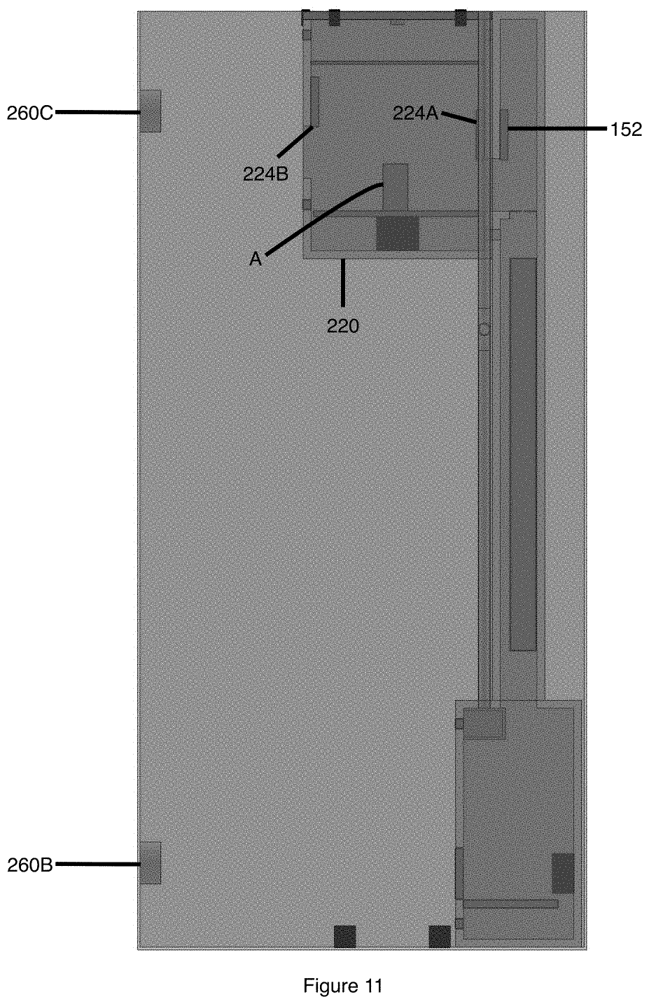

FIG. 10 is a sectioned elevation view of container 220 of the EGS 5 having reached the surface of fluid body 202 and having docked adjacent to upper anteroom 120, with sealable port 224 still closed. Similarly, FIG. 11 is a sectioned elevation view of container 220 of EDS 5 having reached the surface of fluid body 202 and having docked adjacent to upper anteroom 120, but with sealable port 224 having been opened.

A hydraulic pusher 330 pushes array A of objects rightward (in the diagram) out of inner chamber 222 and onto suspension mechanism 116. Hydraulic pusher 330 is under the control of a user and provides a mechanical advantage to the user to allow the user to move the array A out of container 220.

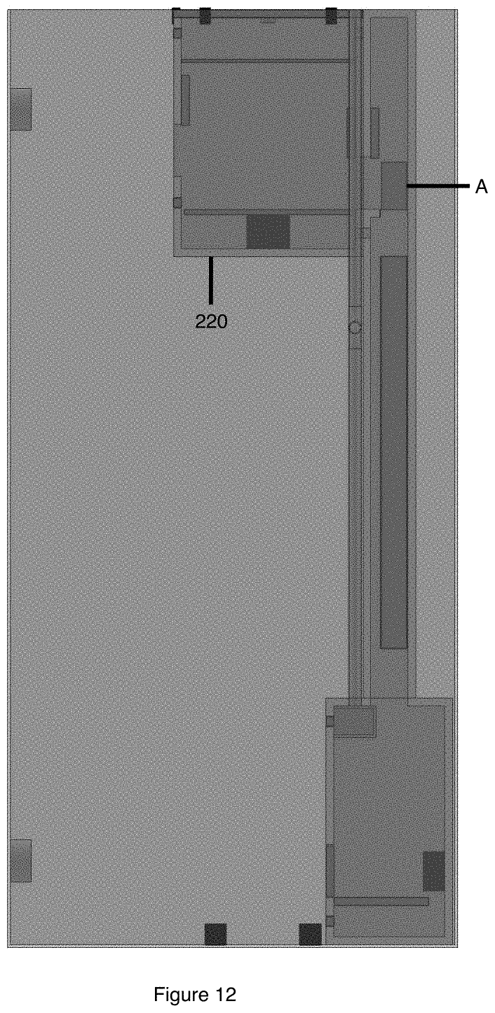

FIG. 12 is a sectioned elevation view of array A of objects 300 having been urged out of container 220 to upper end 112 transducer subsystem 100. With array A of objects 300 having been returned as described above with the use of upthrust through fluid body 202, EGS 5 may proceed to operate to both conduct the dropping again thereby to generate electricity again, and may proceed to put return subsystem 200 back into a condition to receive array A of objects 300 from lower anteroom 150 once they have again been dropped.

It will be appreciated that the time over which the steps shown in FIGS. 7 through 12 will depend on the buoyancy of the combination of container 220 and array A in the fluid body, how tall fluid body is, and how quickly the user (or users) wishes to urge the array A into and out of container 220 at respective points. However, it will also be appreciated that, as compared to the dropping time, the time required during the return can be small, depending on how the system is implemented and chosen to be controlled.

In order to put return subsystem 200 back into a condition to receive array A of objects 300 from lower anteroom 150, container 220 of elevator 210 is conditioned by its buoyancy subsystem to reduce in buoyancy thereby to cause container 220 to tend to sink back downwards.

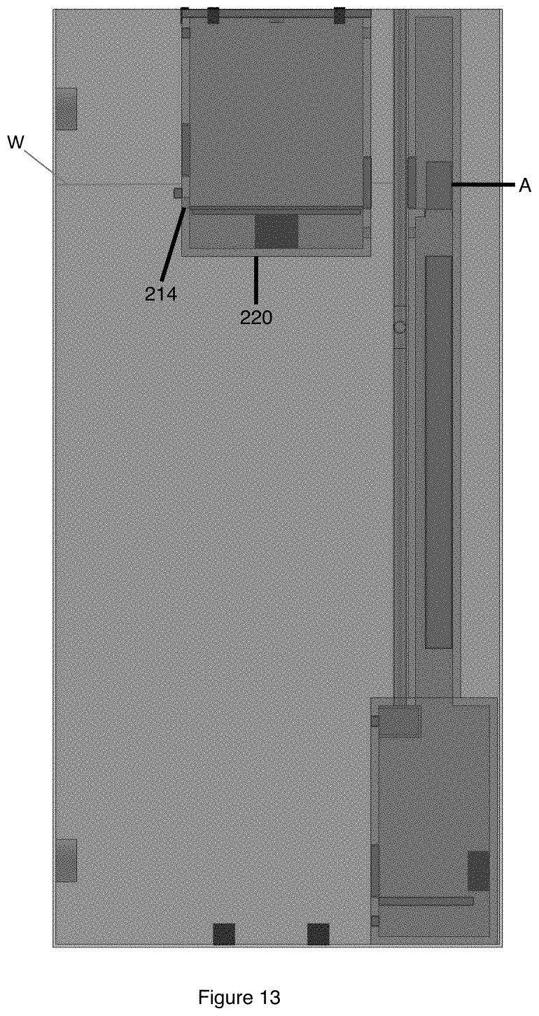

FIG. 13 is a sectioned elevation view of EGS 5 with container 220 in “fill” mode during which fluid from fluid body 202 is permitted to enter into interior chamber 222 thereby to progressively reduce the buoyancy of container 220 with respect to fluid body 202. A waterline W representing the surface of fluid body 202 with respect to container 220 once fully risen and docked, is shown.

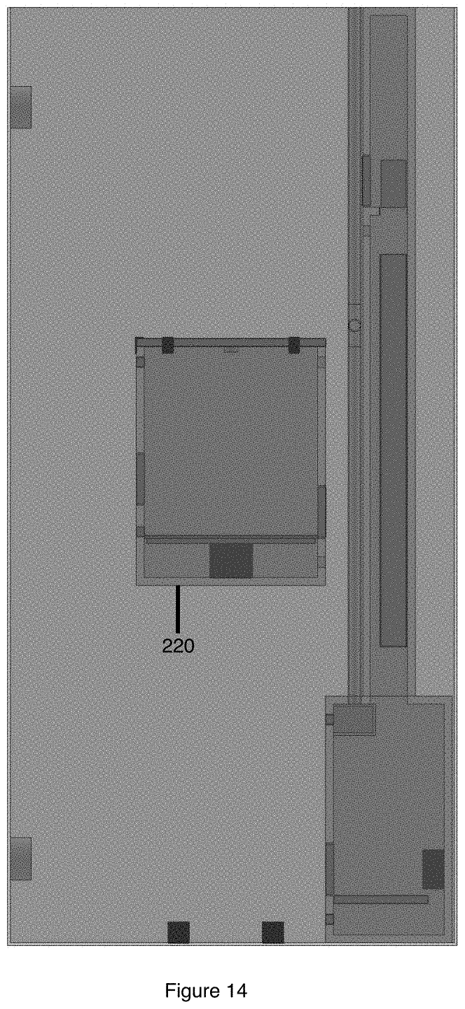

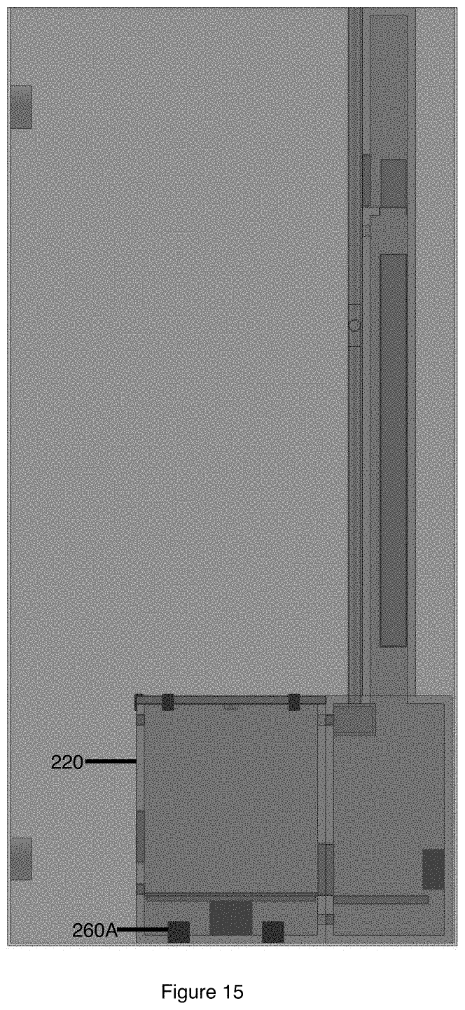

FIG. 14 is a sectioned elevation view of container 220 having been reduced in buoyancy sufficiently to enable container 220 to drop down through fluid body 202 towards lower anteroom 150. FIG. 15 is a sectioned elevation view of container 220 having reached the bottom of fluid body 202 adjacent to lower anteroom 150, and having been again been retained, or docked, by retention mechanism 260A at this position.

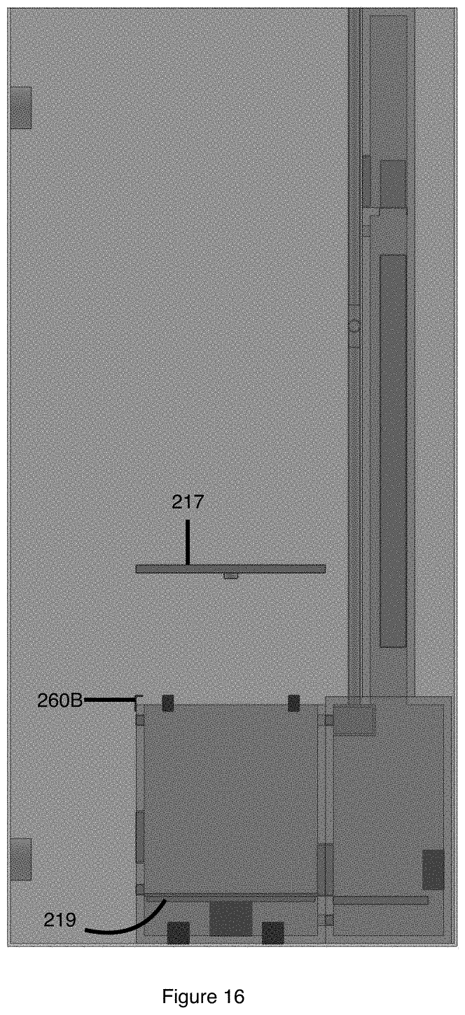

FIG. 16 is an enlarged sectioned elevation view of lid 217 of container 220 having been released in a release state of a respective retention mechanism 260B from upper opening 218 of container 222 as part of the operation of a purge subsystem, thereby to separate from upper opening 218. Retention mechanism 260B otherwise is in a retention state to keep lid 217 in upper opening 218 during rising and sinking. Lid 217 is itself hollow and includes an operable valve for permitting fluid to enter or exit, or block fluid from exiting. In this way, lid 217 can be arranged to be buoyant or not, as will be described. In FIG. 16, lid 217 is buoyant.

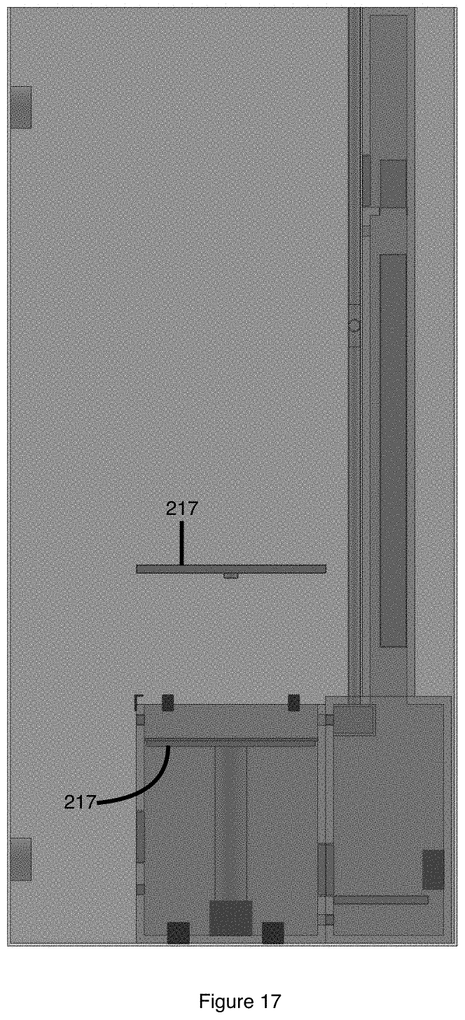

FIG. 17 is a sectioned elevation view of fluid being pushed out of retained container 220 via upper opening 218 of container 220 by riser 219 traversing interior chamber 222 of container 220. As riser 219 traverses interior chamber 22, it purges fluid that had been permitted to enter interior chamber 222 from fluid body 202 to sink container 222 back into fluid body 202. This begins the process of increasing the buoyancy of container 220. In this embodiment, riser 219 pushes an upper plate within inner chamber 222 to in turn push fluid out of container 220. In embodiments, a flexible bag or other structure may hang within container 220 for separating riser 219 from the fluid, and for containing fluid coming into container 220 and keeping such fluid from reaching riser 219. In such an embodiment, riser 219 would push up on the bottom side of the flexible bag when purging the fluid, and would thus not necessarily have to sealingly scrape against all of the inner sides of container 220 to gather and purge most or all of the fluid that had been used to sink container 220. Rather, riser 219 would push the bag, which would in turn purge the fluid.

It will be appreciated that, despite its corresponding increase in buoyancy, container 220 is retained by retention mechanism 260A adjacent to lower anteroom 150 during this process.

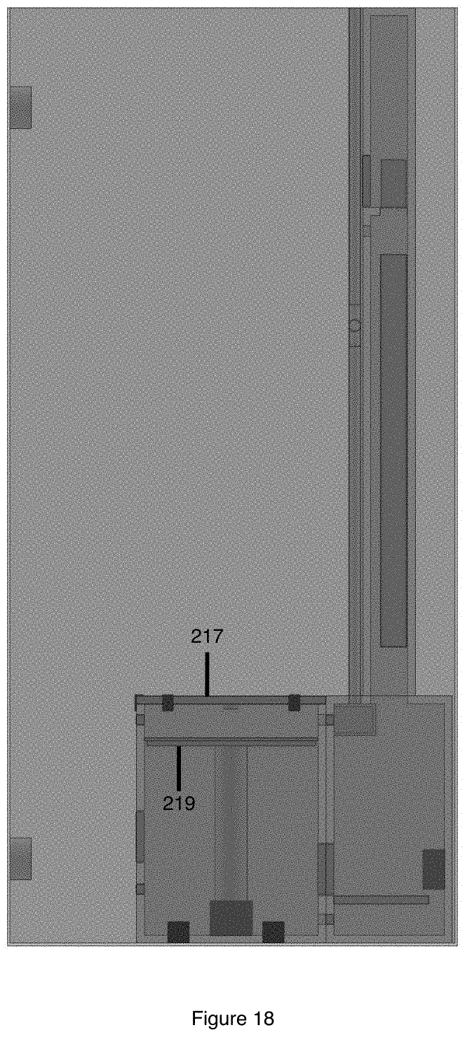

FIG. 18 is an enlarged sectioned elevation view of lid 217, having been filled or partly filled with fluid due to the opening of its valve, and thus itself having lost buoyancy, having returned to container 220 thereby to re-close and seal upper opening 218.

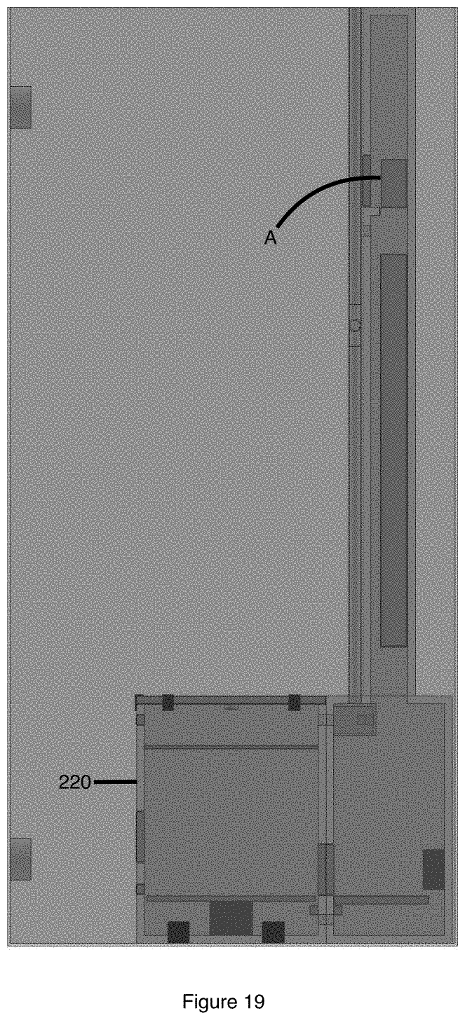

FIG. 19 is an enlarged sectioned elevation view of riser 219 having receded from within interior chamber 222 while upper opening 218 is sealed by lid 217. Interior chamber 222, substantially purged of fluid from fluid body 202, can fill with air drawn from the ambient via air passage arrangements 270A, 270B that permit the upper plate and riser 219 to settle back to initial positions without being impeded by an air lock. The valve in lid 217 can also remain open to drain downwards of its smaller volume of fluid as riser 219 recedes, into the upper part of container 220. Once riser 219 has fully receded, sealable port 224 can be opened to enable container 220 to receive into interior chamber 222 the array A of objects 300 once they have again been dropped into lower anteroom 150.

Although embodiments have been described with reference to the drawings, those of skill in the art will appreciate that variations and modifications may be made without departing from the spirit, scope and purpose of the invention as defined by the appended claims.

For example, while in embodiments disclosed herein an array A of objects 300 is used to generate electricity and is returned using upthrust through a fluid body, in alternative embodiments a single object 300 could be used to generate electricity and could be returned using upthrust. An object 300 might be larger and interact with a larger or longer winding 142 thereby to individually generate a higher current per drop than the individual objects depicted herein. However, it will be appreciated that unless a user wishes to be available immediately after dropping to move the single object into container 230 to be conveyed through the fluid body, such an implementation would not carry the benefit of requiring only a small time investment on the part of the user relative to the time during which electrical current was being generated. In fact, a single object system would very likely require more time of the user than the time during which electrical current was being generated. As such, such a system, while being a DGUR, would not qualify as a SIDGUR.

Furthermore, while in embodiments described herein the transducers are windings 142 in which electrical current is induced because of the magnetic objects 300 moving with respect to the windings 142, alternative and/or additional transducers may be used. For example, an alternative transducer, such as a piezoelectrica transducer, may generate electrical current in response to being physically impacted by dropping objects. It will be appreciated that other impact transducers may be used, and that, in alternative embodiments, an impact transducer may be used in conjunction with a coil transducer or another form of transducer for generating electrical current in multiple ways from a single drop of an object. Other transducers that are neither impact or coil transducers may be suitable.

While particular shapes and relative sizes of components have been depicted, alternatives are possible. Various different shapes, sizes, numbers of parts, relative positions of components, and other adjustments may be deployed in a given implementation of a system that operates using the DGUR and SIDGUR principles described herein. Certain uniformity of object shapes, and certain shapes themselves, may increase the ease with which a user can treat the set of objects as an array and thus, to a degree, as a single thing to be easily moved as described above. This collective treatment by a user of the multiple objects is a useful factor in enabling the user to spend as little time and energy as possible collectively moving the objects between the transducer and return subsystems. As such, uniformity of objects and their physical compactness will tend to enable such objects to more readily be treated efficiently in arrays as a single larger object.

While an object comprising a magnet and a stationary coil arrangement has been described, in embodiments a magnet could be stationary and a coil moved with respect to the magnet. While this would tend to increase the complexity of a system that has to harvest electricity from a moving coil, embodiments incorporating this idea are contemplated.

Furthermore, while embodiments disclosed herein show dropping of objects vertically through respective channels, the principles described herein are applicable to other formats. For example, rather than dropping objects into free fall between the upper anteroom and the lower anteroom, channels may be off vertical such that dropping is more guided. In such an alternative implementation, components could be configured such that objects roll or slide downwards a declining ramp under the influence of gravity and, in doing so, move with respect to a wire winding or interact with another kind of transducer. Alternatively, a combination of ramped falling and free falling of a given object could be implemented, so as to (for example) urge the object in a lower anteroom closer to the elevator's container or even guide the moving object directly into the container, bypassing the need for a user to move the array A into the container at the bottom.

Multiple containers might be used to each carry a portion of the array A of objects 300, or to each carry the full array A at different times.

While a particular buoyancy subsystem has been described, alternatives are possible. For example, it might be useful to sink the container when required by allowing fluid to enter into the interior chamber via its upper opening, rather than solely via the valve. Furthermore, in an alternative embodiment, it might be useful to purge the container through valves in the sidewalls operating in conjunction with pumps, or through the lid of the container, rather than lifting the container lid and having the above-described riser push upwards. Furthermore, in an alternative embodiment, rather than the container lid rising very far from the container opening, it may be buoyant but simply be loosely retained for purging and then drawn back into place, or may not be buoyant but pushed away from the opening and then drawn back into place or allowed to sink back into place. anVarious options are possible.

What is claimed is:

1. A system for generating electrical current comprising:
a transducer subsystem having an upper end and a lower end, the transducer subsystem generating electrical current responsive to objects being dropped individually from the upper end to the lower end under the influence of gravity; and
a return subsystem for returning a plurality of the objects collectively to the upper end using upthrust through a fluid body.

2. The system of claim 1, wherein:
the transducer subsystem comprises at least one stationary transducer having a coil; and
the objects comprise magnets.

3. The system of claim 2, wherein each of the objects is associated with a respective one of the at least one stationary transducer.

4. The system of claim 3, wherein the objects are substantially identical.

5. The system of claim 1, wherein the return subsystem returns all of the objects collectively to the upper end using upthrust through the fluid body.

6. The system of claim 1, further comprising:
a suspension mechanism associated with the upper end of the transducer subsystem for selectively suspending the objects above, and releasing the objects into, the transducer subsystem.

7. The system of claim 1, wherein the return subsystem comprises at least one container dimensioned to convey the plurality of the objects collectively to the upper end.

8. The system of claim 7, wherein each container has an interior chamber and a sealable port through which the objects can be received within the interior chamber, and each container comprises a buoyancy subsystem for conditioning each container to selectively rise or sink within the fluid body.

9. The system of claim 8, wherein the buoyancy subsystem comprises:
a fill subsystem for selectively permitting fluid from the fluid body to enter the interior chamber thereby to reduce buoyancy of the container causing the container to tend to sink in the fluid body; and
a purge subsystem for selectively causing fluid in the interior chamber to be released into the fluid body to increase buoyancy of the container thereby to cause the container to tend to rise in the fluid body.

10. The system of claim 9, wherein the purge subsystem comprises:
a resealable container lid associated with an upper opening of the container; and
a riser for traversing the interior chamber to push fluid within the interior chamber out of the upper opening of the container while the lid is not sealing the container.

11. A method for generating electrical current comprising:
dropping objects individually from an upper end to a lower end of a transducer subsystem under the influence of gravity, wherein the transducer subsystem generates electrical current responsive to the dropping;
harvesting the electrical current; and
returning a plurality of the objects collectively to the upper end using upthrust through a fluid body.

12. The method of claim 11, wherein:
the transducer subsystem comprises at least one stationary transducer having a coil; and
the objects comprises magnets.

14. The method of claim 12, wherein each of the objects is associated with a respective one of the at least one stationary transducer.

15. The method of claim 11, wherein the objects are substantially identical.

16. The method of claim 15, wherein returning comprises returning all of the objects collectively to the upper end using upthrust through the fluid body.

17. The method of claim 11, further comprising:
prior to dropping the objects, suspending the objects above the transducer subsystem.

18. The method of claim 11, wherein the returning comprises:
causing a plurality of the objects to be conveyed collectively within at least one container in the fluid body from the lower end to the upper end.

19. The method of claim 18, further comprising:
causing the plurality of objects to move into the container; and
after the at least one container has conveyed the plurality of objects to the upper end, causing the plurality of objects to move out of the container.

20. The method of claim 19, comprising:
after moving the array of objects out of the at least one container, permitting fluid from the fluid body to enter an interior chamber of the at least one container thereby to reduce buoyancy of the at least one container causing the at least one container to sink within the fluid body towards the lower end of the transducer subsystem;
retaining the at least one container near to the lower end of the transducer subsystem; and
purging fluid from the interior chamber into the fluid body to increase buoyancy of the at least one container thereby to cause the at least one container to tend to rise in the fluid body, wherein the at least one container is temporarily kept from rising despite the increased buoyancy due to the retaining,
wherein the purging fluid comprises:
unsealing a container lid associated with an upper opening of the at least one container;
pushing fluid within the interior chamber out of the upper opening of the at least one container while the lid is unsealed from the at least one container; and
re-sealing the container lid.
